(19) United States
(12) Patent Application Publication
(10) Pub. No.: US 2014/0335481 A1
(43) Pub. Date: Nov. 13, 2014

(54) HEALTH MANAGEMENT SYSTEM, DEVICES, AND RELATED METHODS

(71) Applicants: Michael BUTLER, Midvale, UT (US); Mitch FRIEDLANDER, Salt Lake City, UT (US); Gina DAINES, Holladay, UT (US)

(72) Inventors: Michael BUTLER, Midvale, UT (US); Mitch FRIEDLANDER, Salt Lake City, UT (US); Gina DAINES, Holladay, UT (US)

(21) Appl. No.: 13/890,968

(22) Filed: May 9, 2013

(51) Int. Cl. G09B 19/00

(52) U.S. Cl. CPC G09B 19/0092
USPC 434/127

(57) ABSTRACT

An electronic device for managing a health plan comprises an electronic display and a processor configured to maintain a meal plan to be displayed on the electronic display. The meal plan has a plurality of meals as guidance for a user to consume during a day. The processor is further configured to switch a meal of the plurality of meals with a specific meal offered by a specific entity. The specific meal can have substantially the same nutritional characteristics as the meal being switched out. A computer-readable medium including instructions stored thereon, that when executed by a processor may cause the processor to manage a meal database. A related method for managing a health management system is disclosed that includes switching the meal from the meal plan with a specific meal from the one or more specific meals.

### TECHNICAL FIELD

Embodiments of the disclosure generally relate to personal health management systems, devices, and related methods to assist users in managing health information, such as diet and exercise plans.

### BACKGROUND

Having a healthy and balanced diet and making sound nutritional choices is an important part of healthy living. People have long sought ways to improve their health by controlling (e.g., lose, gain, or maintain) body weight, building muscle, monitoring diet choices to achieve a well-balanced diet. Doing so may improve a person's physical health, as well as their mental health. Entire industries have been formed to assist individuals who seek assistance in health management.

Some conventional health management systems (e.g., diet programs, exercise programs, etc.) may recommend a plan for achieving certain health goals. For example, the plan may define the specific foods, times to eat, and exercises to be performed. It is then the responsibility of the individual following the plan to adhere to the rules, guidelines, and other recommendations of the plan. Following the plan may require self-motivation and discipline. At times, however, it may not be desired, practical, or even possible to follow every recommendation provided in the plan. As a result, the person may do things that fall outside the scope of the plan because of a lack of information, becoming less motivated, or becoming undisciplined when the person must make choices that are not specifically outlined in the plan. As a result, the individual may not achieve the desired results, in part, because of not following the health plan as well as they could have.

### SUMMARY

Embodiments of the present disclosure include an electronic device for managing a health plan. The electronic device comprises an electronic display and a processor operably coupled with the electronic display. The processor is configured to maintain a meal plan to be displayed on the electronic display, the meal plan having a plurality of meals as guidance for a user to consume during a day. The processor is further configured to switch a meal of the plurality of meals with a specific meal offered by a specific entity, the specific meal having substantially the same nutritional characteristics as the meal being switched out.

Another embodiment of the present disclosure includes a computer readable medium including instructions stored thereon. When executed by a processor, the instructions cause the processor to manage a meal database including nutritional information for a plurality of specific meals offered by one or more entities, query the meal database in response to retrieving input parameters corresponding to nutritional information of a meal from a meal plan, and return search results from the query. The search results include at least one specific meal of the plurality that has nutritional information that as within a tolerance level of the nutritional information of the meal from the meal plan that is being switched.

An alternative embodiment includes a method for managing a health management system. The method comprises querying a meal database having a plurality of specific meals offered by one or more specific entities, limiting search results from the query to one or more specific meals that are substantially similar as a meal of a meal plan for a user for a plurality of nutritional categories, each of the one or more specific meals offered as a meal by a company, and switching the meal from the meal plan with a specific meal from the one or more specific meals.

### BRIEF DESCRIPTION OF THE OF THE DRAWINGS

FIG. 1 is a flowchart illustrating a health management system according to an embodiment of the present disclosure.

FIGS. 2 through 5, 6A, 7A, 7C, 8A, and 9 show various screen shots of exemplary graphic user interfaces (GUIs) that a user may use to navigate between and interact with during operation of the health management system.

FIG. 6B is a flowchart illustrating a method of switching a meal within a meal plan according to an embodiment of the present disclosure.

FIG. 7B is a flowchart illustrating a method for locating a meal to be included within a result list for a user to select from when switching meals of a meal plan according to an embodiment of the present disclosure.

FIG. 7D is a flowchart illustrating a method for locating a meal to be included within a result list for a user to select from when switching meals of a meal plan according to an embodiment of the present disclosure.

FIG. 8B is a flowchart illustrating a method for locating a meal to be included within a result list for a user to select from when switching meals of a meal plan according to an embodiment of the present disclosure.

### DETAILED DESCRIPTION

In the following description, reference is made to the accompanying drawings in which are shown, by way of illustration, specific embodiments of the disclosure. The embodiments are intended to describe aspects of the disclosure in sufficient detail to enable those skilled in the art to make, use, and otherwise practice the claimed invention. Other embodiments may be utilized and changes may be made without departing from the scope of the disclosure. The following detailed description is not to be taken in a limiting sense, and the scope of the claimed invention is defined only by the appended claims and their equivalents.

Furthermore, specific implementations shown and described are only examples and should not be construed as the only way to implement or partition the disclosure into functional elements unless specified otherwise herein. It will be readily apparent to one of ordinary skill in the art that the various embodiments of the disclosure may be practiced by numerous other partitioning solutions.

In the following description, modules, programs, and functions may be shown in block diagram form in order not to obscure the disclosure in unnecessary detail. Additionally, block definitions and partitioning of logic between various blocks is exemplary of a specific implementation. It will be readily apparent to one of ordinary skill in the art that the disclosure may be practiced by numerous other partitioning solutions. The various illustrative logical blocks, modules, programs, and functions described in connection with the embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration. Computer-readable media includes both computer storage media and communication media, including any medium that facilitates transfer of a computer program from one place to another.

Also, it is noted that the embodiments may be described in terms of a process that may be depicted as a flowchart, a flow diagram, a structure diagram, or a block diagram. Although a process may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. If implemented in software, the functions may be stored or transmitted as one or more instructions (e.g., code) on computer readable media.

The instructions stored on a computer-readable medium may cause a processor to perform one or more operations described herein. Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Embodiments of the present disclosure include a health management system, one or more electronic devices, computer-readable media, and related methods. The health management system may assist a user in creating a diet and/or exercise plan customized to assist a user to reach their fitness goals (e.g., losing weight, building muscle, being more toned, etc.) based on their current situation. The health management system may be configured to maintain a meal plan for a user. In some embodiments, the health management system may provide a recommended meal plan for a user. The recommended meal plan may be tailored to the individual user based on a variety of factors, such as total daily calorie intake, daily nutrients, the user's exercise habits, and so forth. As a result, the meal plan may include meals (e.g., main course, side dishes, etc.) recommended to the user for breakfast, lunch, and dinner. In some embodiments, the recommended meal plan may be generated by a personal nutrition advisor on an individual basis. In some embodiments, the recommended meal plan may be selected from among a set of pre-stored meal plans. The pre-stored meal plans may be templates that were created for a variety of different body types, health situations, exercise habits, and fitness goals. As a result, the information provided by the user may be used by the health management system to select the pre-stored meal plan that is appropriate for the user.

In some embodiments, the user may desire to create their own meal plan that is stored in the health management system. For example, the users may have some familiarity with selecting an appropriate meal plan for themselves. If the user creates their own meal plan, the user-generated meal plan may also be made available to the community of users of the health management system. In other words, users may also select from other user-generated meal plans stored in the system that have been shared by other users within the community of users. For example, the user may browse and/or search user-generated meal plans that are available for sharing in order to find and select a meal plan that the user feels is well-suited to their needs.

The user-generated meal plans may also include at least some profile information for the user so that other users may view the desired goals, outcomes, body types, etc. for which the user-generated meal plan was designed. Sharing such additional information may further assist other users to find and select meal plans that are particularly applicable to their situation.

Meal plans (e.g., recommended, user-generated, etc.) may be combined with a workout plan as well. Thus, the health management system may provide users with an overall health plan that includes both a diet and an exercise routine that the user may choose to follow. Different combinations of meal plans and workout plans may be recommended to achieve different outcomes.

After a health plan (e.g., meal plan, workout plan) is selected by a user, the health management system may provide information (e.g., details, schedule, etc.) to the user to encourage the user to follow the health plan to achieve the desired results. In some situations, however, it may not be desired, practical, or even possible for the user to consume a particular meal of the selected meal plan. As a result, the user may desire to switch (e.g., swap, exchange, etc.) at least one meal of the selected meal plan with another meal. The meal may be switched with a different meal having substantially similar nutritional characteristics.

For example, in some embodiments, the health management system may include a meal locator feature that is configured to search for a suitable meal to replace an existing meal in the meal plan. The meal locator feature may search through a database that includes nutritional information for specific meals from specific restaurants (e.g., fast food, fine dining, etc.) and/or specific prepared meals available at a store. The meal locator may return specific meals that are available within a desired area requested by the user. For example, the user may define the desired area by entering a postal code (e.g., zip code) for an area where the user desires to eat. In some embodiments, the user may define the desired area based on the user's current location with the assistance of a global positioning system (GPS) device that may be integrated with the user's electronic device. The search results may be also filtered according to search parameters (e.g., calories, protein, fat, carbohydrates, user preferences) that are substantially similar to the outgoing meal being switched. As a result, the user may be able to locate foods anytime and anywhere that the user may eat without deviating from the meal plan.

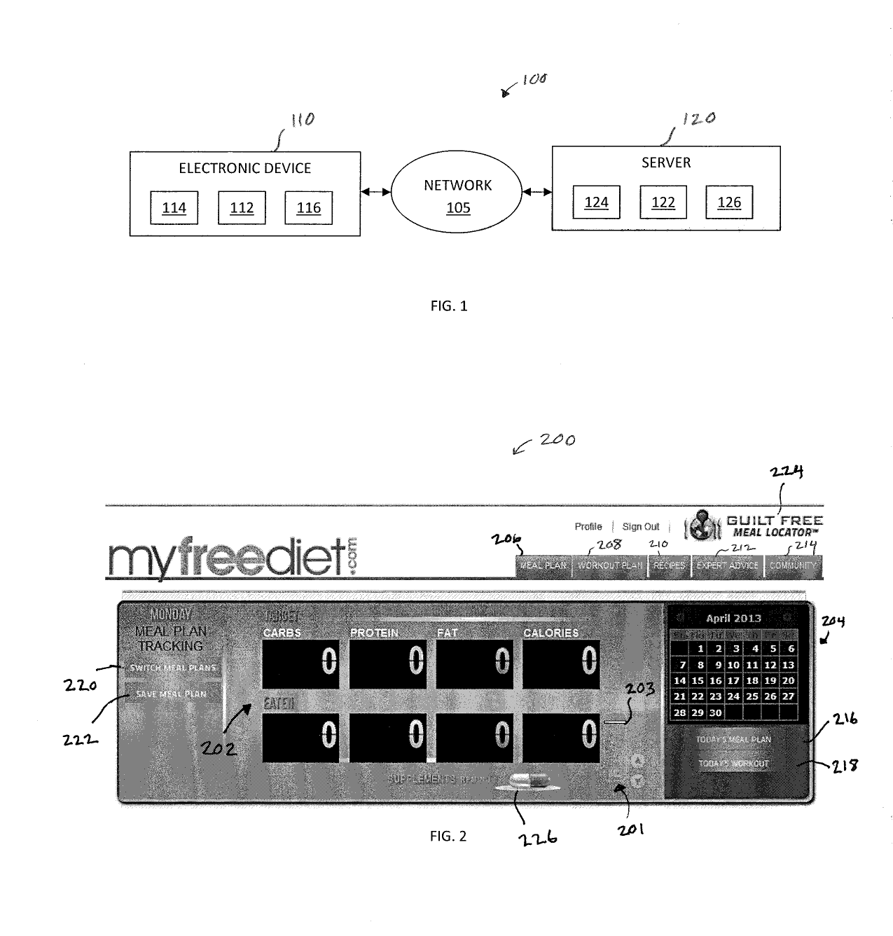

FIG. 1 is a health management system 100 according to an embodiment of the present disclosure. The health management system 100 may include an electronic device 110 that may couple with a server 120 over a network 105, such as the Internet. Of course, the server 120 may be configured to communicate with a plurality of electronic devices 110. In addition, the server 120 may include a plurality of servers 120 such that more than one server 120 may exist to perform the various operations described herein.

The electronic device 110 may include a processor 112, a memory 114, input/output devices 116, etc. The input/output devices 116 may include input devices such as a touch screen, keyboard, mouse, microphone, camera, etc. such that the electronic device 110 may receive inputs from a user. The input/output devices 116 may include output devices, such as an electronic display, speakers, etc. Examples of electronic devices 110 include smart phones, tablet computers, personal computers, and other similar devices.

The server 120 may also include a processor 122, a memory 124, and input/output devices 126. The electronic device 110 may be configured to communicate with the server 120 to perform various methods described herein. Each of the memories 114, 124 may be a computer-readable medium that includes instructions (e.g., software code, application programs, etc.) that may be stored thereon, that may be executed by the processors 112, 122 to perform the various methods described herein. The server 120 may include one or more databases, which may include meal information (e.g., prepared, dine out), company information, brand information, recipe information, workout information, etc. described more fully below. Additional databases may include account databases including the authentication and profile information of the users.

The health management system 100 may be accessed by the user through an application program running on the electronic device 110. In some embodiments, the electronic device 110 operate as a thin client (e.g., through a web browser, mobile application, etc.) that displays the information via a graphical user interface that the user interacts with to communicate with the server 120. As a result, the electronic device 110 may be configured to send information and requests for the server 120 to process. For example, the server 120 may also be configured to run an application program that performs data processing steps to query databases in response to the requests received from the electronic device 110. In some embodiments, at least some data may be stored locally in a cache of the electronic device 110. Thus, the processing for the operations described herein may be performed on the electronic device 110, the server 120, or a combination thereof.

The user may view and interact with the health management system 100 through one or more graphical user interfaces (GUIs). FIGS. 2 through 5, 6A, 7A, 7C, 8A, and 9 show various screen shots of exemplary GUIs that a user may use to navigate between and interact with during operation of the health management system 100.

When the user desires to access the health management system 100, the user may login to the health management system 100 through a user account. If the user does not have a user account created, the user may be prompted to create a new user account. When creating a new user account, the user may input login information (e.g., user name, password, etc.) as well as profile information. The user may save the new account information, which is added to an authentication database that is used to only allow authorized accesses to the user account.

The profile information may include identifying and contact information, such as name, gender, birth date, email address, physical address, etc. The profile information may further include additional information related to the user's body type (e.g., height, weight, cellulite, etc.), current stress levels (e.g., none, low, medium, high, etc.), sleeping habits, energy levels (e.g., time of day when energy seems high or low), levels of depression, or other information related to the user's body, current physical or mental wellbeing, habits, or other related information.

Additional information may include the user's health goals (e.g., lose weight, build muscle, maintain wellness, etc.) including desired areas for improvement (e.g., improve abdomen, waist, legs, buttocks, arms, back, etc.). The user may also enter the user's current physical activity level (e.g., sedentary, light activity, medium activity, heavy activity, etc.) and fitness experience level (e.g., beginner, intermediate, advanced, etc.).

Further additional information may include preferences, such as the preferred type of workout (e.g., gym workout, home workout, etc.), the preferred type of meal preparation (e.g., whether or not the user likes to cook, eat prepared meals, or dine out). Other preferences entered by the user may include diet preferences (e.g., low carbohydrate, vegan, vegetarian, gluten free, low fat, low sodium, dairy free, food allergies, likes/dislikes, etc.).

FIG. 2 is a GUI 200 that may display various information and links associated with the health management system 100 of FIG. 1. For example, the GUI 200 may display nutritional information 202, a calendar 204, and a plurality of links 206, 208, 210, 212, 214, 216, 218, 220, 222, 224, 226 that a user may select to navigate the GUI 200, as well as to select various features, enter information, and initiate operations enabled by the GUI 200. For convenience, the term “link” is used herein to indicate any feature that may be selected by a user to perform one or more of the operations described herein. For example, selecting a link may navigate between pages, open a new window, access information, initiate operations, and so on. A link is intended as a general term that may include buttons, drop down menus, and other similar features that are selectable by a user, as is known in the art. For example, although a plurality of links are located at different locations on the GUI 220, one or more links may be combined within a drop down menu from which the user may select the desired link.

The nutritional information 202 may display a target nutritional information for a particular day. The target nutritional information may be based on the meal plan or other parameters selected by the user. For example, the target nutritional information may include the total carbohydrates (carbs), protein, fat, and calories that are set as the respective target for the user for a particular day. For example, the target nutritional information may be a sum total of each category of the selected meal plan for each meal of the entire day.

The nutritional information 202 may further include a running total for the nutritional information eaten by the user for the particular day. Like the target nutritional information, the running total may include the total carbohydrates (carbs), protein, fat, and calories for all food that is actually consumed during the day. As a result, the user can visually compare the nutritional information from their food intake to the target as the day goes on.

The GUI 200 may further include a water intake icon 201. The user may increase or decrease the water shown by the water intake icon 201 to reflect the amount of water the user has consumed during the day. The user may compare their water intake against a recommended threshold 203 displayed by the water intake icon 201.

The calendar 204 may display a calendar for a desired time period (e.g., week, month, multiple months, etc.) from which the user may select a particular date to view a meal plan, workout information, and other information related to the date selected. The user may select the current date (today) to have the information for the current date to be displayed. The user may also select a date in the past to view a history of a particular day. The user may further select a date in the future to view information related to a particular day in the future. For example, the user may desire to prepare for the meals for that particular day in advance, switch meals in advance, etc.

If the user desires to view the meal plan home page, the user may select the meal plan link 206. If the user desires to view workout plans, the user may select the workout plan link 208. If the user desires to view recipes, the user may select the recipes link 210. If the user desires to view expert advice, the user may select the expert advice link 212. If the user desires to view community information, the user may select the community link 214. If the user desires to view today's meal plan, the user may select the today's meal plan link 216. If the user desires to view today's workout, the user may select the today's workout link 218. If the user desires to switch meal plans, the user may select the switch meal plan link 220. Switching the meal plan may include selecting one of a recommended meal plan or a meal plan that the user may search. If the user desires to save a meal plan, the user may select the save plan link 222. Saving a meal plan may enable the users to create their own meal plan template that is used as their meal plan. If the user desires to locate a meal, the user may select the meal locator link 224. If the user desires to view dietary supplement information, the user may select the supplements link 226. For example, the user may enter what supplements the user is taking and then have the health management system 100 send a reminder (e.g., via email, text message, or other message) for when the user should take the supplement. At least some of the additional functionality associated with these links may be discussed below.

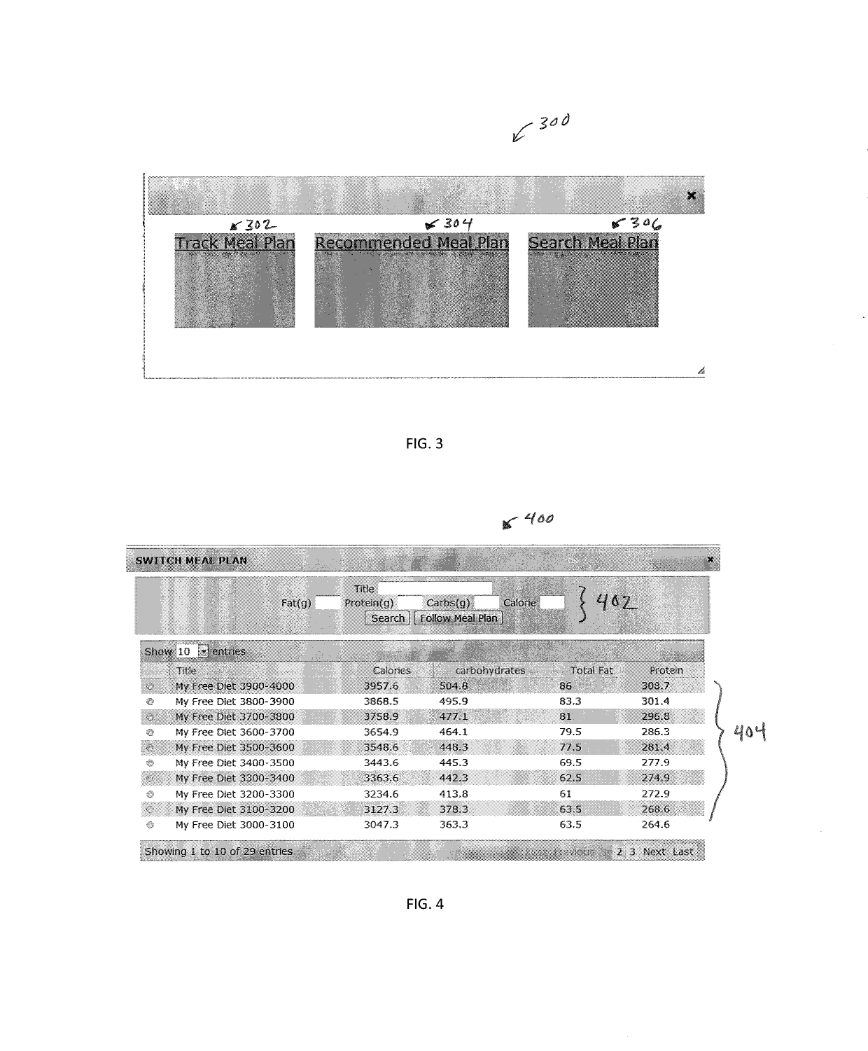

FIG. 3 is a GUI 300 that may open if the user selects a meal plan (e.g., switch meal plan link 220 (FIG. 2)). The track meal plan link 302 may enable the user to operate the health management system 100 simply as a diet journal rather than a meal planner. The recommended meal plan link 304 may enable the user to view and save a recommended meal plan from the health management system 100 (FIG. 1). The recommended meal plan may be offered by the health management system 100 based on the criteria entered by the user as profile information, such as exercise habits, health goals, current health state, preferences, etc. For example, the health management system 100 may include a number of stored meal plans, from which the health management system 100 may recommend a meal plan to the user. The stored meal plans may include pre-stored meal plans that are created by a nutritionist as templates for different circumstances based on a combination of factors. The health management system 100 may recommend a meal plan having the characteristics that most closely aligns with the profile information provided by the user.

The search meal plan link 306 may enable the user to search for a meal plan. The user may enter search parameters (e.g., nutritional information, goals, etc.) to search through the stored meal plans. In some embodiments, the user may simply browse through the stored meal plans and select the meal plan of their choice. Stored meal plans may include the pre-stored meal plan templates created by a nutritionist for the health management system 100. Stored meal plans may also include user-generated meal plans that the users have allowed to be shared with other users within the community of the health management system 100. The user may select the desired meal plan, which is then associated with that user as its meal plan. The meal plan may include a list of food to be consumed for each meal (e.g., breakfast, lunch, dinner) as well as snacks (if any) that are part of the plan.

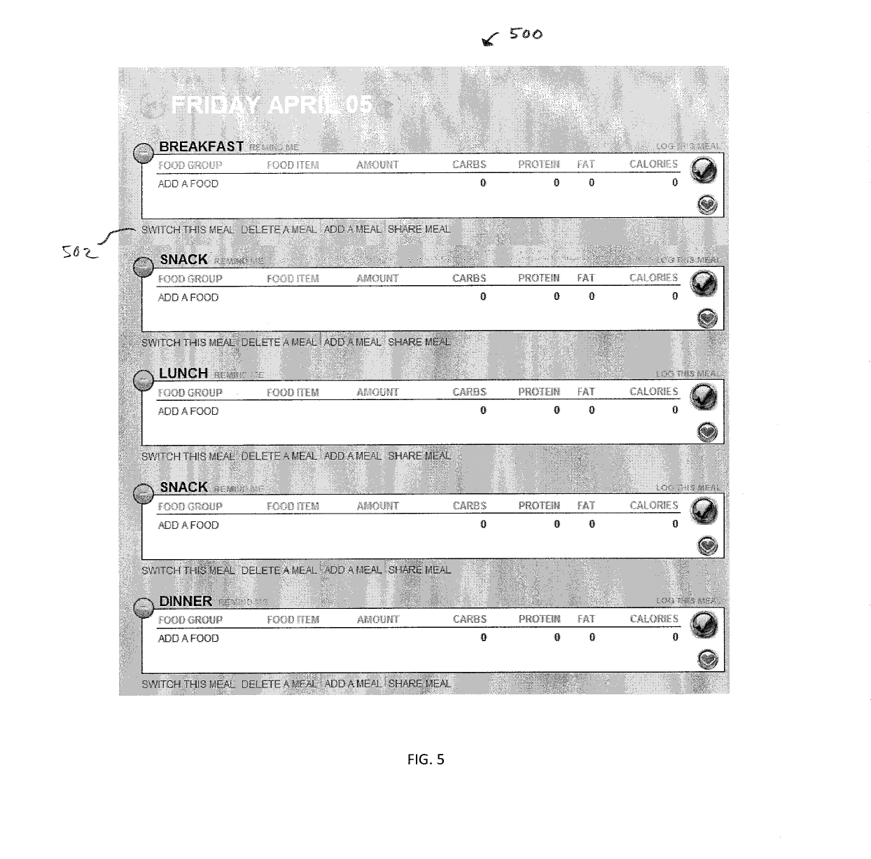

FIG. 4 is a GUI 400 that may open if the user selects the search meal plan link 306 (FIG. 3) associated with the switch meal plan link 220 (FIG. 2). The GUI 400 may include search inputs 402, such as a meal plan title and nutritional information (e.g., carbs, protein, fat, calories) used as parameters for the meal plan search. Thus, the user may filter the search results 404 by inputting one or more desired parameters into the search inputs 402. The nutritional information entered into the GUI 400 may be the daily nutritional information for the desired meal plan. The health management system 100 may consider other preferences for the search, such as diet preferences (e.g., low carbohydrate, vegan, vegetarian, gluten free, low fat, low sodium, dairy free, etc.). Such diet preferences may not need to be entered into the GUI 200 if they were stored in the user's preferences, such as when the user account was created.

In some embodiments, the user may decide to browse all meal plans stored in the health management system 100. Once a desired meal plan is found that is desired by the user, the user may select the desired meal plan for the user to then follow. The selected meal plan may be stored as the meal plan for the user to follow.

FIG. 5 is a GUI 500 that displays a meal plan for a given date. The meal plan may include a plurality of meals (e.g., breakfast, lunch, dinner) as well as snacks that may be part of the meal plan. Each meal/snack may include one or more food items, with the associated nutritional information (e.g., food group, carbs, protein, fat, calories) listed therewith. The GUI 500 may also enable the user to edit meals within the meal plan, including switching the meal, deleting the meal, adding a meal, adding a food time, deleting a food item, etc. The GUI 500 may further enable the user to share a meal with the other users of the health management system 100. The switch this meal link 502 is labeled with a reference numeral as it will be described more fully below.

In some embodiments, the user may share meals or even entire meal plans with other users of the health management system 100. The user may designate that all users of the health management system 100 may access such shared information. In some embodiments, however, the user may be given the option to share such information with a limited number or group of users of the health management system 100. For example, the user may elect to share meal or meal plan information with friends or acquaintances that the user is connected to (e.g., through an associated social media platform).

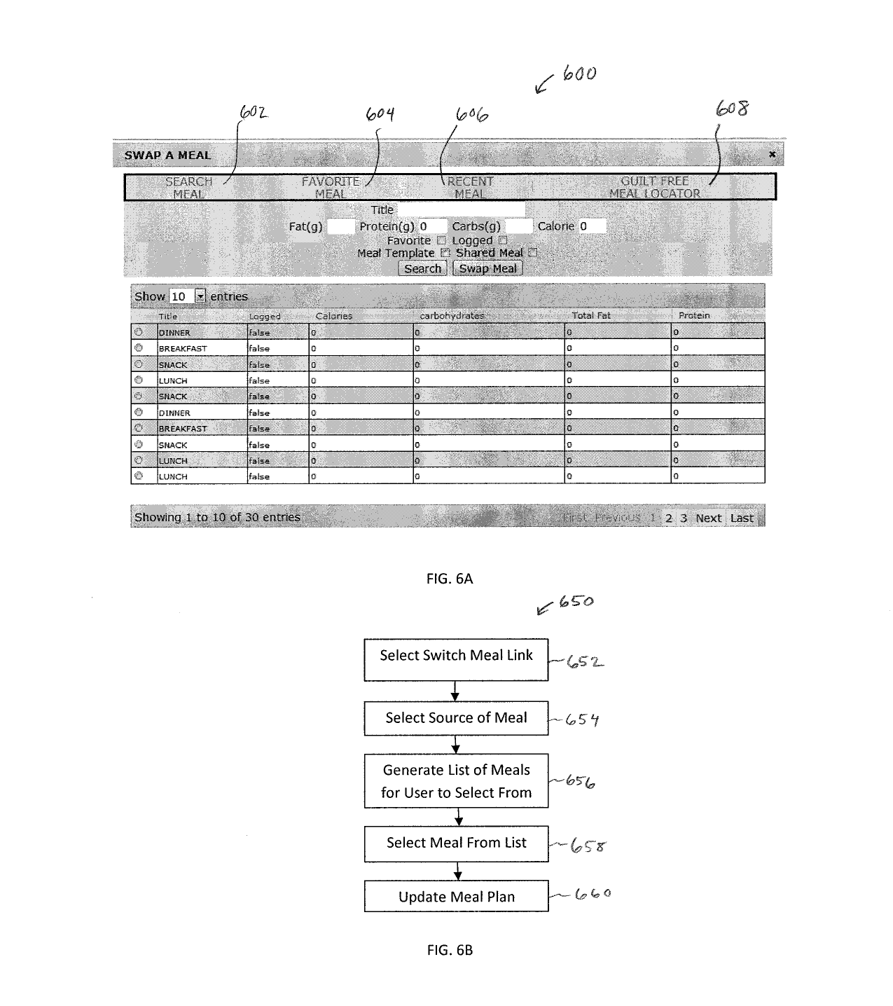

FIG. 6A is a GUI 600 that may open if a user desires to switch a meal and selects the appropriate link (e.g., switch this meal link 502 (FIG. 5)). To switch a meal, the user may select which meal is desired to be switched, as well as enter the method for switching the meal. For example, the user may switch the meal by searching a meal 602, searching a favorite meal 604, searching for a recent meal 606, or using a meal locator feature 608.

FIG. 6B is a flowchart 650 illustrating a method of switching a meal within a meal plan according to an embodiment of the present disclosure. At operation 652, the user may select the switch this meal link 502 (FIG. 5) for the meal which is desired to be switched out. At operation 654, the user may select the source of the meal to be switched in. For example, the user may select one of the search meal link 602, favorite meal link 604, recent meal link 606, and meal locator link 608.

At operation 656, the health management system 100 may generate a list of meals for the user to select from. For example, the list of meals may correspond to the source that the user selected in operation 654. At operation 658, the user may select the desired meal from the results list. At operation 660, the health management system 100 may update the user's meal plan by switching out the original meal of the meal plan and switching in the meal selected by the user from the results list.

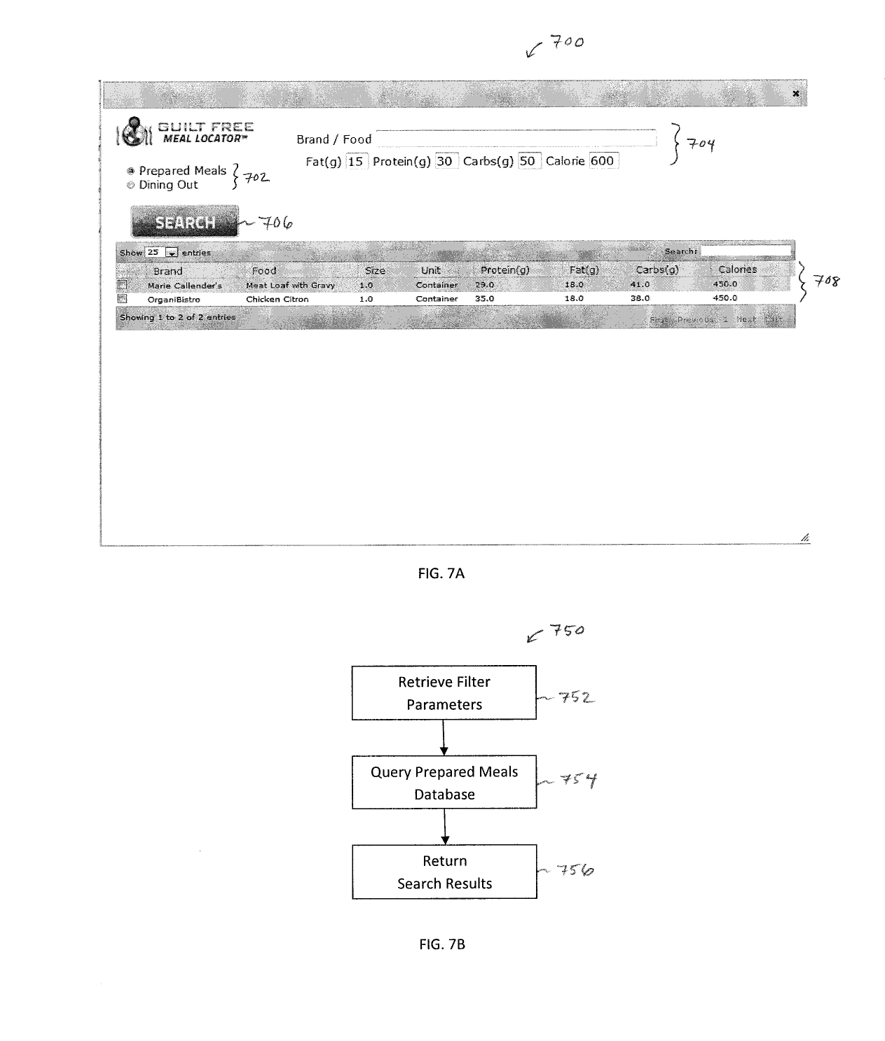

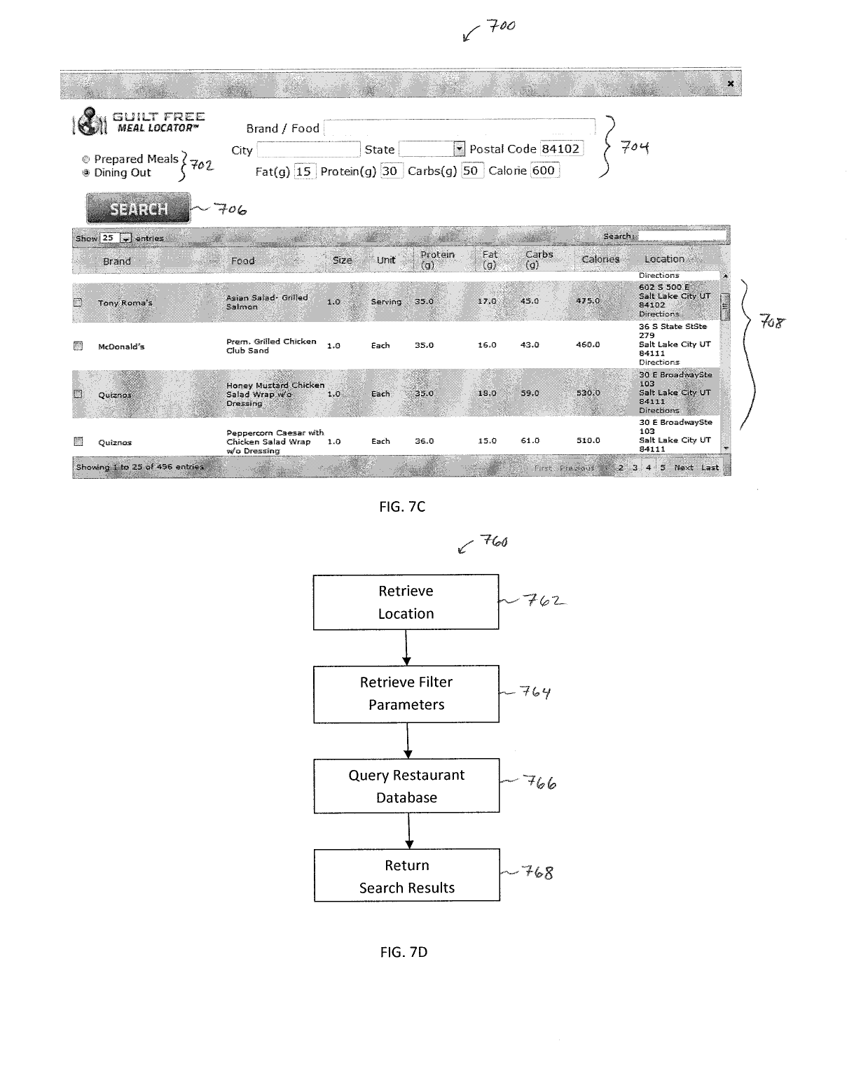

FIGS. 7A and 7C is a GUI 700 that may open if a user desires to locate a meal and selects the appropriate link (e.g., meal locator link 224 (FIG. 2), meal locator link 608 (FIG. 6)). The meal type input 702 is shown as a plurality of radio buttons from which the user may select the meal type (e.g., prepared meals, dining out) desired to be located. Of course, it is recognized that the meal type input 702 may be configured as any input type (e.g., manual input field, drop down menu, etc.). As shown in FIG. 7A, the user has selected prepared meals as the meal type. As used herein, prepared meals include pre-made meals, such as TV dinners, frozen meals, packaged meals, etc. that a user may purchase from a store (e.g., supermarket, convenience store, etc.) rather than a restaurant.

The GUI may further include input fields 704 (e.g., fat, protein, carbs, calories, brand/food). In some embodiments, the user may manually enter parameters into the input fields 704. For embodiments where the meal locator is used to switch a meal from a pre-existing meal plan, the nutritional information from the outgoing meal may automatically populate the corresponding input fields 704 so that the switched in meal is substantially similar to the switched out meal in terms of the nutritional characteristics. If the user has a particular brand or food they desire, they may enter that information in as well. Otherwise, the search will look for any brand or food that meets the criteria entered into the other input fields 704. If the user selects the search button 706, the health management system may perform the desired search and display the search results 708. From the search results 708, the user may select the desired meal to be added to the meal plan. In some embodiments, the search results may include information regarding locations (e.g., supermarkets, Wal-Mart, Target, etc.) that offer the prepared meals for sale. The prepared meals returned as search results may be specific meals offered by third party companies (brands) as a prepared meal.

FIG. 7B is a flowchart 750 illustrating a method for locating a meal to be included within result list for a user to select from when switching meals of a meal plan according to an embodiment of the present disclosure. At operation 752, the filter parameters may be retrieved by the health management system 100. For example, the desired nutritional information, brand, and/or food entered into the input fields 704 may be retrieved. At operation 754, the prepared meals database may be queried, with the information contained within the prepared meals database compared with the filter parameters to return the results of the search. The prepared meals database may include known nutritional information regarding the specific prepared meals offered by the third party companies. The search results may be determined based on a prepared meal having parameters that are substantially similar to those entered into the input fields 704. At operation 756, the search results may be returned. As discussed above, the processing for the search may be performed on the electronic device 110 (FIG. 1), the server 120 (FIG. 1), or a combination thereof.

In some embodiments, a tolerance level may be set for each category of the nutritional information. For example, the tolerance level may be set at ±25% of the parameters entered into the input fields 704. As a result, the nutritional information may not necessarily have to be an exact match for an incoming meal to replace an outgoing meal when switching meals of a meal plan using the meal locator feature. For example, as shown in FIG. 7A, the nutritional information for each category is relatively close to corresponding category entered as the filter parameters, but not exact. In order for the entry to show up in the search results, each category may be required to be within tolerance.

Of course, the tolerance level of 25% is used herein as an example. Some embodiments may have a stricter or more lenient tolerance level. In addition, some embodiments may be configured to permit the user to set their own tolerance level rather than having a fixed tolerance level programmed into the health management system 100. Setting the tolerance level may be determined and/or edited with the other profile and account information for the user account. In some embodiments, the tolerance levels for each individual category may be set independently of each other. For example, the user may desire to be more strict for fat (e.g., tolerance=10%) while remaining lenient on carbs (e.g., tolerance=20%). The lower the tolerance levels are set to be, the more similar the switched meals will be. As a result, the meal plan may be less compromised as deviations from the meal plan may be reduced. Of course, reducing the tolerances may provide fewer search results for the user to choose from.

In some embodiments, the search results 708 may be displayed in the GUI 700 in order of one of the categories (e.g., calories) from low to high or high to low. In some embodiments, the search results 708 may be ordered alphabetically by brand name or food type. In some embodiments, the search results 708 may be displayed in other orders. For example, the top results in the display may be the results that as a whole deviate the least from the input parameters. For example, an average deviation may be calculated across all categories to determine the order for which the entries are displayed in the search results 708.

FIG. 7C shows the GUI 700 having the dining out option selected as the meal type desired to be searched. When the dining out option is selected, the input fields 704 may further include fields for locational information (i.e., location criteria) to be entered. Locational information may be used to limit the search to a particular geographic region. The locational information may be entered manually by the user, such as by address, city, state, postal code (e.g., zip code), or a combination thereof. In some embodiments, the locational information may include GPS data, such as may be retrieved using built-in GPS devices of the electronic device 110 that may determine the current location of the user. The locational information may be converted to a latitude and longitude value or other coordinate used to identify a location or area.

FIG. 7D is a flowchart 760 illustrating a method for locating a meal to be included within result list for a user to select from when switching meals of a meal plan according to an embodiment of the present disclosure. At operation 762, the desired location for the restaurant may be retrieved. For example, the desired location may be input by the user by address, city, state, postal code, or other locational information. In some embodiments, the desired location may be based on the current location of the user, which may be determined by GPS data retrieved by the user's electronic device 110.

At operation 764, the filter parameters may be retrieved similarly as described above. At operation 766, the restaurant database may be queried. The restaurant database may include known nutritional information regarding the specific meals offered on the menus of the specific restaurants. This operation may be similar to the query operation described above in that each category of nutritional information may be compared to determine if the meal entry is a match (within tolerance) that is returned as a search result. An additional filter for the restaurant database is to compare against locational information of the restaurants. This information may be stored in the restaurant database. To reduce the amount of information stored in the restaurant database (e.g., all restaurant locations everywhere) some of the locational information for the restaurants may be pulled from online sources as the method is being performed. The locational information may also be provided with some flexibility in terms of tolerance level (e.g., within 1 mile, 5 miles, 10 miles, etc.).

At operation 768, the search results that meet the search criteria may be returned and displayed on the electronic device 110. The search results may include specific meals (e.g., menu items) for specific restaurants that are within the area desired by the user. The search results may be displayed alphabetically by restaurant, by proximity to the user, by one of the categories of nutritional information, or some other method. For example, the top results in the display may be the results that as a whole deviate the least from the input parameters. For example, an average deviation may be calculated across all categories to determine the order for which the entries are displayed in the search results 708.

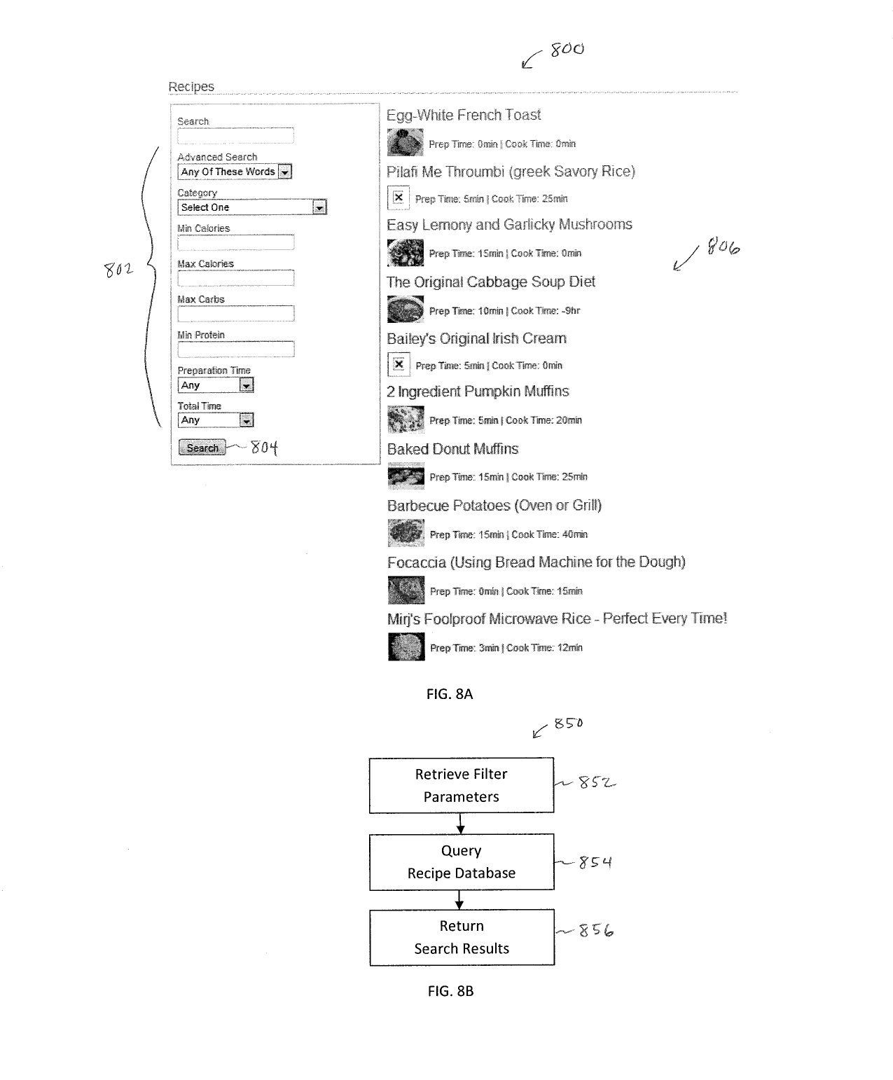

FIG. 8A is a GUI 800 that may open if a user desires to locate a recipe for a meal and selects the appropriate link (e.g., recipes link 210 (FIG. 2)). The GUI 800 may include input fields 802, which may enable the user to enter one or more of the following: search terms (e.g., key words), a category for a meal, desired nutritional information (e.g., calories, carbs, protein, fat, etc.), preparation time, cook time, and/or total time (preparation+cook time).

If the user selects the search button 804, the health management system 100 (FIG. 1) may populate a search results field 806 with recipes that fall within the parameters used to filter the search results. The user may then select a recipe to view. In some embodiments, the recipe may be saved as a meal within the user's meal plan (e.g., as a switched meal). In such embodiments, the nutritional information from the outgoing meal in the meal plan may be automatically filled into the input fields for the nutritional information used as the parameters for the search. As a result, the recipes that are returned as the search results may have substantially similar nutritional characteristics as the first meal being switched out of the user's meal plan. Of course, the user may manually enter and/or change the parameters entered into the input fields 802, if desired.

FIG. 8B is a flowchart 850 illustrating a method for locating a meal to be included within result list for a user to select from when switching meals of a meal plan according to an embodiment of the present disclosure.

At operation 852, the filter parameters may be retrieved. For example, the filter parameters may include the parameters entered into the input fields 802 prior to the user selecting the search button 804. In some embodiments, the filter parameters may be sent from the electronic device 110 (FIG. 1) to and received by the server 120 (FIG. 1) for further processing of the search.

At operation 854, the recipe database may be queried. For example, the server 120 may have a plurality of recipes stored thereon as a recipe database that includes the description, category, nutritional information, preparation time, cook time, total time, etc. for each recipe of the recipe database. In some embodiments, the server 120 and/or electronic device 110 may query a plurality of databases that have recipe information rather than all recipe information being stored by the server 120. For example, the server 120 may perform an internet search of one or more recipe websites that maintain their own recipe databases. At operation 856, the search results may be returned. As a result, the search results 806 may be displayed by the GUI 800.

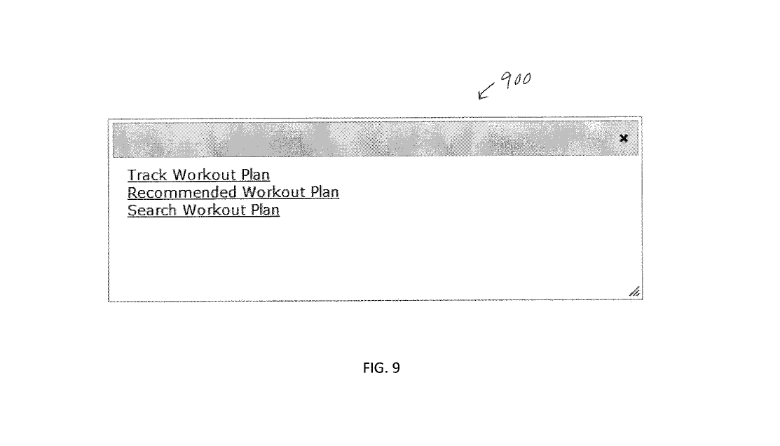

FIG. 9 is a GUI 900 that may open if a user desires to view, select, and/or edit a workout plan and selects the appropriate link (e.g., workout plan link 208 (FIG. 2)). The user may be able to select the desired workout plan in a similar manner to the meal plan. For example, the user may track their own workout plan as an exercise journal. In some embodiments, the user may desire a recommended workout plan, which may be recommended to the user by the health management system 100. The selection of the workout plan from a plurality of pre-stored workout plans to offer as the recommended workout plan may be based on the meal plan selected, and other information and goals provided by the user. In some embodiments, the user may search other workout plans to select a plan that is desirable to the user. The workout plans that are available during the search may include the pre-stored workout plans available as templates by the health management system 100, as well as user-generated workout plans that other users have made available to the community of users of the health management system 100.

Although the foregoing description contains many specifics, these are not to be construed as limiting the scope of the disclosure, but merely as providing certain exemplary embodiments. Similarly, other embodiments of the disclosure may be devised which do not depart from the scope of the disclosure. For example, features described herein with reference to one embodiment also may be provided in others of the embodiments described herein. The scope of the claimed invention is, therefore, indicated and limited only by the appended claims and their legal equivalents, rather than by the foregoing description.

What is claimed is:

1. An electronic device for managing a health plan, the electronic device comprising:
an electronic display; and
a processor operably coupled with the electronic display, the processor configured to:
maintain a meal plan to be displayed on the electronic display, the meal plan having a plurality of meals as guidance for a user to consume during a day; and
switch a meal of the plurality of meals with a specific meal offered by a specific entity, the specific meal having substantially the same nutritional characteristics as the meal being switched out.

2. The electronic device of claim 1, wherein the nutritional characteristics include at least one of calories, fat, protein, and carbohydrates.

3. The electronic device of claim 1, wherein substantially the same nutritional characteristics includes the nutritional characteristics of the specific meal being within a threshold value for its respective category of the nutritional characteristics.

4. The electronic device of claim 1, wherein the processor is further configured to generate a graphical user interface (GUI) that is displayed on the electronic device, the GUI configured to display the meal plan, and to interact with a user to control a health management system including the processor.

5. The electronic device wherein the GUI is one of a web browser and a mobile application interface.

6. The electronic device of claim 1, wherein the specific entity is a restaurant and the specific meal includes at least one item from a menu of the restaurant.

7. The electronic device of claim 1, wherein the specific entity is a food production company and the specific meal includes at least one prepared meal.

8. The electronic device of claim 1, wherein the processor is configured to transmit the nutritional characteristics of the meal being switched out to an external server for comparison with the nutritional characteristics of the specific meal.

9. A computer readable medium including instructions stored thereon, that when executed by a processor, cause the processor to:
manage a meal database including nutritional information for a plurality of specific meals offered by one or more entities;
query the meal database in response to retrieving input parameters corresponding to nutritional information of a meal from a meal plan;
return search results from the query, the search results including at least one specific meal of the plurality that has nutritional information that as within a tolerance level of the nutritional information of the meal from the meal plan that is being switched.

10. The computer-readable medium of claim 9, wherein the tolerance levels for each category of the nutritional information are pre-determined to have the same value.

11. The computer-readable medium of claim 9, wherein the tolerance levels for at least two categories of the nutritional information have different values.

12. The computer-readable medium of claim 9, wherein the nutritional information include one or more categories of nutritional information that are selected from the group consisting of protein, fat, carbohydrates, and calories.

13. The computer-readable medium of claim 9, wherein querying the meal database is further responsive to retrieving input parameters corresponding to locational information defining an area of interest, and wherein the at least one specific meal returned from the query is offered by a restaurant that is geographically within the area of interest.

14. A method for managing a health management system, the method comprising:
querying a meal database having a plurality of specific meals offered by one or more specific entities;
limiting search results from the query to one or more specific meals that are substantially similar as a meal of a meal plan for a user for a plurality of nutritional categories, each of the one or more specific meals offered as a meal by a company; and
switching the meal from the meal plan with a specific meal from the one or more specific meals.

15. The method of claim 14, further comprising selecting the meal plan.

16. The method of claim 15, wherein selecting the meal plan includes selecting a recommended meal plan that is tailored to the user based one or more of a health status, body type, exercise habits, and diet preferences.

17. The method of claim 15, wherein selecting the meal plan includes selecting a shared meal plan generated by another user of the health management system.

18. The method of claim 14, comprising further limiting the search results from the query such that the company is located within a desired area based on locational data provided by the user.

19. The method of claim 18, wherein locational data includes data selected from the group consisting of a city, a state, a postal code, global positioning system data, and combinations thereof.

20. The method of claim 14, wherein the meal offered by a company is a prepared meal offered by a food service company.
